(19) United States
(12) Patent Application Publication
(10) Pub. No.: US 2026/0202986 A1
(43) Pub. Date: Jul. 16, 2026

(54) 3D DRAM WITH CMOS-BASED SECONDARY MEMORY

(71) Applicant: Micron Technology, Inc., Boise, ID (US)

(72) Inventors: Makoto Kitagawa, Folsom, CA (US); Christopher K. Morzano, Boise, ID (US)

(21) Appl. No.: 19/415,261

(22) Filed: Dec. 10, 2025

Related U.S. Application Data
(60) Provisional application No. 63/745,589, filed on Jan. 15, 2025.

(51) Int. Cl. G06F 3/06

(52) U.S. Cl. CPC G06F 3/0655; G06F 3/0604; G06F 3/0673

(57) ABSTRACT

Devices and techniques that provide for a wafer-on-wafer interconnect architecture that optimizes wafer usage and reduces general-purpose input/output (GIO) delay are described herein. A memory device may include a complementary metal-oxide-semiconductor (CMOS) wafer, the CMOS wafer including controller circuitry and a secondary memory device; and a memory array wafer comprising a memory array of a plurality of memory cells, the memory array wafer stacked on the CMOS wafer using wafer-on-wafer interconnect architecture, the plurality of memory cells arranged in pages, rows, and columns, wherein the secondary memory device is configured to store metadata for at least a portion of the pages.

### PRIORITY APPLICATION

This application claims the benefit of priority to U.S. Provisional Application Ser. No. 63/745,589, filed Jan. 15, 2025, which is incorporated herein by reference in its entirety.

### BACKGROUND

Memory devices are typically provided as internal, semiconductor, integrated circuits in computers or other electronic devices. There are many diverse types of memory including volatile and non-volatile memory. Volatile memory can require power to maintain data and includes random-access memory (RAM), dynamic random-access memory (DRAM), and synchronous dynamic random-access memory (SDRAM), among others. Non-volatile memory can provide persistent data by retaining stored data when not powered and can include NAND flash memory, NOR flash memory, read only memory (ROM), Electrically Erasable Programmable ROM (EEPROM), Erasable Programmable ROM (EPROM), and resistance variable memory such as phase change random access memory (PCRAM), resistive random-access memory (RRAM), and magnetoresistive random access memory (MRAM), 3D XPoint™ memory, among others.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

To easily identify the discussion of any particular element or act, the most significant digit or digits in a reference number refer to the figure number in which that element is first introduced.

FIG. 1 illustrates an example of an environment including a host device and a memory device configured to communicate over a communication interface, according to an embodiment.

FIG. 2 is a schematic of an electrical arrangement of components of an embodiment of an example DRAM device, according to an embodiment.

FIG. 3 is a diagram illustrating memory architectures, according to an embodiment.

FIG. 4 is a diagram illustrating a memory device, according to an embodiment.

FIG. 5 illustrates timing diagrams of a “read command to first data” measurement, according to an embodiment.

FIG. 6 is a flowchart illustrating an example method that may be implemented in a memory device to respond to a read request, according to an embodiment.

FIG. 7 is a flowchart illustrating an example method that may be implemented in a memory device to respond to a write request, according to an embodiment.

FIG. 8 illustrates a block diagram of an example machine with which, in which, or by which any one or more of the techniques (e.g., methodologies) discussed herein can be implemented.

### DETAILED DESCRIPTION

Aspects of the present disclosure are directed to manufacturing or using hybrid memory structures, such as those included in or used in 3D DRAM. Memory devices with memory arrays arranged in a three-dimensional manner, referred to herein as 3D memory arrays, may be arranged in a three-dimensional manner logically or physically, such as, for example, in a 3D DRAM device. A memory array that is arranged in a three-dimensional manner may comprise memory cells that are addressable for reading and writing in three dimensions. Consider an example memory array in which a first dimension is indicated by columns of memory cells, a second dimension is indicated by rows of memory cells and a third dimension is indicated by pages of memory cells. In this example, each memory cell may be identified by a unique combination of column, row, and page. Consider an example 3D DRAM device having memory cells that are arranged physically in three dimensions. Memory cells may be arranged into columns and rows parallel to a die substrate. Various tiers of rows and columns may be built up from the die substrate, where each tier may constitute a page of memory cells.

Consider an example in which memory cells are arranged in a three-dimensional manner into rows, columns, and pages, and for which the susceptibility of errors increase with increasing page number (e.g., pages farther from the plane of the die). A selected number of columns may be used to store parity data with respect to other columns in the same page. Additionally, a selected number of columns may be used to store column redundancy data. Further, in some implementations, a hybrid column may store parity data for a first set of pages and other data (e.g., column redundancy) for a second set of the pages. The first set of pages may use an (additional) parity bit, increasing the robustness of error detection and correction. At the same time, the memory cells of the hybrid column that are not needed to store one or more parity bits for the second set of pages may be used for other storage purposes such as, for example, to provide additional column redundancy as described herein. In some examples, the first set of pages may be pages that are more likely to experience errors such as, for example, pages of some 3D DRAM devices that are farther from the plane of the die.

In some examples, memory cells of a hybrid column corresponding to the second set of pages may be used as column redundancy memory cells. For example, column redundancy columns of memory cells may be memory cells created in a memory array during fabrication. If one or more columns of memory cells in the memory array are found to be defective, for example, during or after fabrication, the memory device may be reconfigured such that read and write request that would otherwise have been directed to or from the defective column or columns are, instead, directed to memory cells in the column redundancy column. In this way, overall yield may be increased as the fabrication process may be tolerant to the failure of some limited number of columns. Accordingly, using the memory cells of a hybrid column corresponding to less-error-prone memory cells for column redundancy may increase the overall fabrication yield.

In some examples, a memory device can include an error correction circuit. When data is written to the memory device, the error correction circuit may generate one or more parity bits describing the data to be written (e.g., an error correction code (ECC)). Both the data to be written and the ECC parity bits are written to memory cells at the memory device.

The memory device can receive a read command indicating a portion of the memory cells to be read. Read data and its corresponding ECC parity bits are sensed from the indicated memory cells. The error correction circuit uses the parity bits to detect bit errors that may have occurred in the read data and, in some examples, to correct detected bit errors.

The extent of bit errors that are detectable and correctable may depend on the number of parity bits used. For example, using some example error correction code (ECC) algorithms, storing one parity bit per 8-bit word may allow the error correction circuit to detect up to two bit errors per 8-bit word and correct a single bit error. Similarly, using two parity bits per 8-bit word may allow the error correction circuit to detect three bit errors per 8-bit word and correct as many as two bit errors per 8-bit word. Accordingly, using additional parity bits may allow the detection and correction of more significant bit errors at the memory cells, but at the expense of reduced storage efficiency resulting from the storage of the additional parity bits.

Wafer-on-wafer (WoW) interconnect architecture is an advanced semiconductor manufacturing technique that stacks multiple wafers on top of each other to create a 3D integrated circuit (3D IC). This approach enables improved performance, higher density, and reduced power consumption in electronic devices compared to traditional two-dimensional (2D) ICs. In WoW interconnect architecture, two or more semiconductor wafers are fabricated separately, and then the wafers are aligned and bonded together, either face-to-face (frontside) or back-to-back (backside). After bonding, the wafers are processed to create electrical connections between the layers using techniques such as through-silicon vias (TSVs) or microbumps. 3D DRAM is one example of packaging that uses WoW technology.

Key advantages of WoW interconnect architecture include: 1) Increased Integration Density: Stacking wafers allows more components to be packed into a smaller footprint (e.g., smaller die size), enhancing overall system performance; 2) Improved Power Efficiency: Reducing the distance between functional units on different wafers leads to lower power consumption and reduced signal latency; 3) Enhanced Performance: The close proximity of components enables faster communication between different layers, improving data processing speeds; and 4) Heterogeneous Integration: Different types of wafers (e.g., logic, memory, sensors) can be integrated, allowing for the creation of more versatile and multifunctional chips.

The systems and methods described herein provide for a WoW interconnect architecture that optimizes wafer usage and reduces general-purpose input/output (GIO) delay. Memory constructed using WoW technology, such as 3D DRAM and 3D NAND, includes at least one complementary metal-oxide-semiconductor (CMOS) wafer and at least one array wafer. The CMOS wafer(s) may be disposed above or below the array wafer(s). The CMOS wafer includes control logic, such as a memory control circuit, memory manager, or array controller. The array wafer includes memory cells arranged in a number of devices, planes, sub-blocks, blocks, or pages. An improved architecture moves some of the data that may be stored in DRAM to the CMOS wafer. The CMOS wafer may use a storage device (e.g., static random-access memory (SRAM) module) to store the data that was previously stored in the array wafer. The CMOS wafer may store ECC data, global column redundancy (GCR) data, Per Row Activation Counting (PRAC) data, or the like. By relocating data from the array wafer to the CMOS wafer, the implementation provides improved timing and reduced die size (silicon area). Additional details are set forth below.

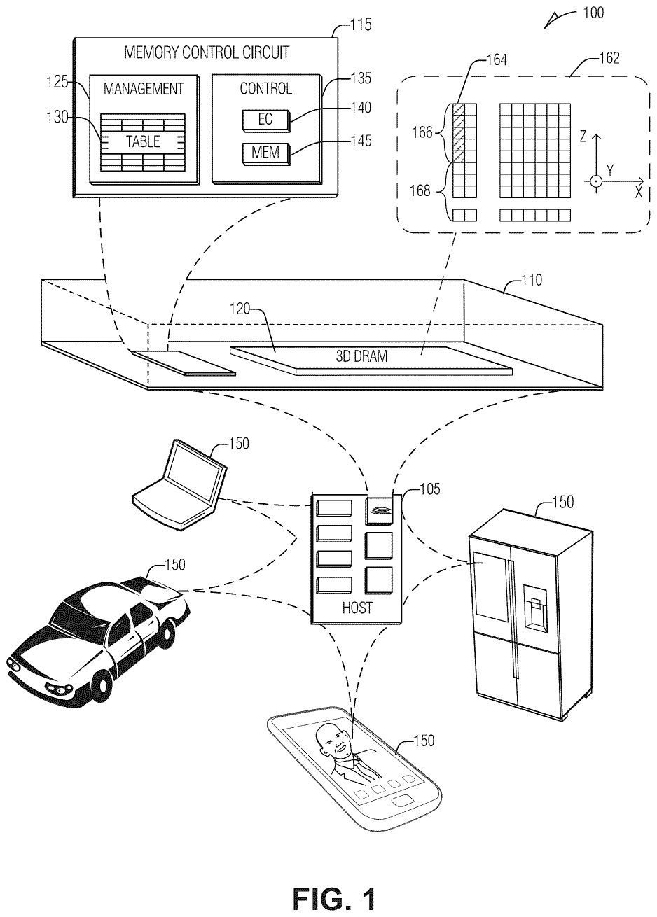

FIG. 1 illustrates an example of an environment 100 including a host device 105 and a memory device 110 configured to communicate over a communication interface, according to an embodiment. A product 150 may incorporate or integrate the host device 105 and the memory device 110. The product 150 may include such things as Internet of Things (IoT) devices (e.g., a refrigerator or other appliance, sensor, motor, or actuator, etc.), a mobile communication device, an automobile, a drone, a computers (e.g., laptop computers, desktop computers, or the like), or the like.

The memory device 110 includes a memory control circuit 115 and a memory array 120 including, for example, one or more individual memory dies (e.g., one or more 3D DRAM arrays). In 3D architecture semiconductor memory technology, vertical structures are stacked, increasing the number of tiers, physical pages, and accordingly, the density of a memory device (e.g., a storage device). In an example, the memory device 110 can be a discrete memory or storage device component of the host device 105. In other examples, the memory device 110 can be a portion of an integrated circuit (e.g., system on a chip (SOC), etc.), stacked or otherwise included with one or more other components of the host device 105.

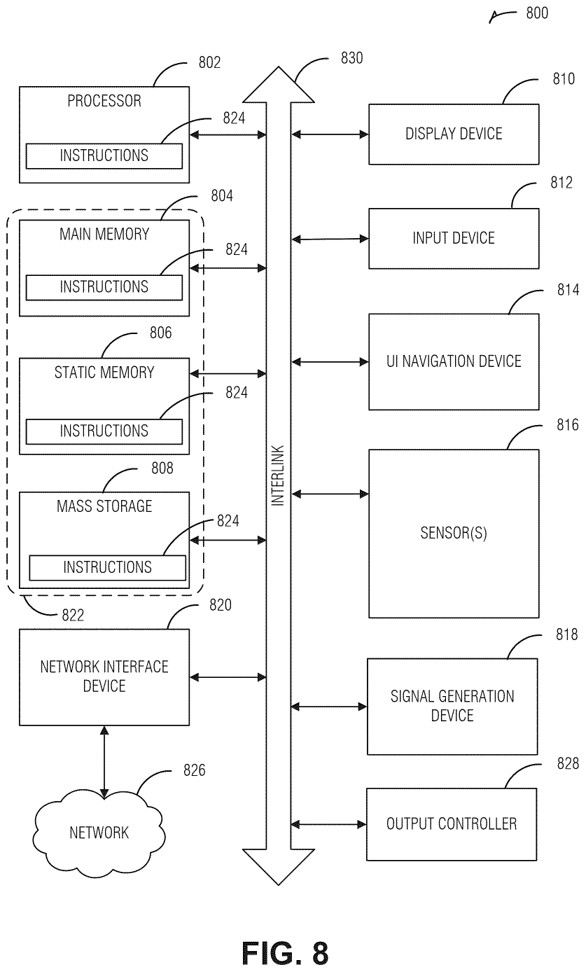

One or more communication interfaces can be used to transfer data between the memory device 110 and one or more other components of the host device 105. Interfaces may include, for example, a Serial Advanced Technology Attachment (SATA) interface, a Peripheral Component Interconnect Express (PCIe) interface, a Universal Serial Bus (USB) interface, a Universal Flash Storage (UFS) interface, an eMMC™ interface, or one or more other connectors or interfaces. The host device 105 can include a host system, an electronic device, a processor, a memory card reader, or one or more other electronic devices separate from the memory device 110. In some examples, the host device 105 may be a machine having some portion, or all, of the components discussed in reference to the machine 800 of FIG. 8.

Electronic devices, such as mobile electronic devices (e.g., smart phones, tablets, etc.), devices for use in automotive applications (e.g., automotive sensors, control units, driver-assistance systems, passenger safety or comfort systems, etc.), and internet-connected appliances or devices (e.g., IoT devices, etc.), have varying storage needs depending on, among other things, the type of electronic device, use environment, performance expectations, etc.

Electronic devices can be broken down into several main components: a processor (e.g., a central processing unit (CPU) or other main processor); memory (e.g., one or more volatile or non-volatile RAM memory device, such as DRAM, mobile or low-power double-data-rate synchronous DRAM (DDR SDRAM), etc.); and a storage device (e.g., non-volatile memory (NVM) device, such as flash memory, ROM, an SSD, an MMC, or other memory card structure or assembly, etc.). In certain examples, electronic devices can include a user interface (e.g., a display, touchscreen, keyboard, one or more buttons, etc.), a graphics processing unit (GPU), a power management circuit, a baseband processor, or one or more transceiver circuits, etc.

The memory control circuit 115 can receive instructions from the host device 105, and can communicate with the memory array 120, such as to transfer data to (e.g., write or erase) or from (e.g., read) one or more of the memory cells, planes, sub-blocks, blocks, or pages of the memory array 120. The memory control circuit 115 can include, among other things, circuitry, or firmware, including one or more components or integrated circuits. For example, the memory control circuit 115 can include one or more memory control units, circuits, or components configured to control access across the memory array 120 and to provide a translation layer between the host device 105 and the memory device 110. The memory control circuit 115 can include one or more input/output (I/O) circuits, lines, or interfaces to transfer data to or from the memory array 120. The memory control circuit 115 can include a memory manager 125 and an array controller 135.

The memory manager 125 can include, among other things, circuitry or firmware, such as a number of components or integrated circuits associated with various memory management functions. For purposes of the present description, example memory operation and management functions are described in the context of DRAM memory. Persons skilled in the art will recognize that other forms of non-volatile memory may have analogous memory operations or management functions. Such DRAM management functions include memory cell refresh, error detection or correction, or one or more other memory management functions. The memory manager 125 can parse or format host commands (e.g., commands received from a host) into device commands (e.g., commands associated with operation of a memory array, etc.), or generate device commands (e.g., to accomplish various memory management functions) for the array controller 135 or one or more other components of the memory device 110.

The memory manager 125 can include a set of management tables 130 configured to maintain various information associated with one or more components of the memory device 110 (e.g., various information associated with a memory array, one or more memory cells coupled to the memory control circuit 115, or one or more memory devices in the memory control circuit 115). For example, the management tables 130 can include information regarding one or more error counts (e.g., a write operation error count, a read bit error count, a read operation error count, an erase error count, etc.) for one or more portions of the memory cells coupled to the memory control circuit 115.

The array controller 135 can include, among other things, circuitry or components configured to control memory operations associated with writing data to, reading data from, or erasing one or more memory cells of the memory device 110 coupled to the memory control circuit 115. The memory operations can be based on, for example, host commands received from the host device 105, or internally generated by the memory manager 125 (e.g., associated with refreshing, error detection or correction, etc.).

The array controller 135 can include an error correction circuit 140. In some examples, the error correction circuit 140 is arranged to implement error correction code (ECC) or another suitable error correction algorithm. For example, when data is to be written to a page or other subunit of memory cells of the memory array 120, the error correction circuit 140 may generate one or more parity bits based on the data. The parity bits are written to one or more memory cells at the memory array 120, for example, in a parity column associated with the data. When data is read from the memory array 120, the data and its associated one or more parity bits are provided to the error correction circuit 140. The error correction circuit 140 may use the parity bits to, if possible, detect and correct any bit errors that may have occurred. In some examples, the error correction circuit 140 may be implemented in software that is executed by a processor, a microcontroller, or other suitable hardware at the memory control circuit 115.

The array controller 135 can include a memory device 145. The memory device 145 may be an SRAM device, in an embodiment. The memory device 145 can be used to store information related to data stored in the memory array 120. For instance, the memory device 145 may be used to store column redundancy data for one or more rows, or one or more pages, in the memory array 120. The memory device 145 may store the column redundancy date in place of, or in addition to, the data stored in the memory array 120. Other types of data may be stored in the memory device 145, such as parity data (ECC data), PRAC data, or the like. Additionally, the memory device 145 may be configured to store more than one type of data. For example, the memory device 145 may store parity data and GCR data for one or more pages of the memory array 120.

The memory array 120 can include memory cells arranged in, for example, a number of devices, planes, sub-blocks, blocks, or pages. In some examples, the memory array 120 may be arranged in three dimensions physically or logically. For example, memory cells in the memory array 120 may be arranged in rows, columns, and pages, as described herein. In some examples, data is written to or read from the memory array 120 in pages. Each page may comprise a memory cell corresponding to a combination of rows and columns, as described herein. In some examples, one or more memory operations (e.g., read, write, erase, etc.) can be performed on larger or smaller groups of memory cells, as desired.

A page of data can include a number of bytes of user data (e.g., a data payload including a number of sectors of data) and its corresponding metadata. A size of the page can refer to the number of bytes used to store the user data. As an example, a page of data can have a page size of 128 bits of user data (e.g., 8 columns of 8 bits) as well as a number of bytes (e.g., 32 B, 54 B, 224 B, etc.) of metadata corresponding to the user data, such as integrity data (e.g., error detecting or correcting code data), address data (e.g., logical address data, etc.), or other metadata associated with the user data.

Different types of memory cells or memory arrays can provide for different page sizes, or may use different amounts of metadata associated therewith. For example, different memory device types may have different bit error rates, which can lead to different amounts of metadata to ensure integrity of the page of data (e.g., a memory device with a higher bit error rate may use more bytes of parity data than a memory device with a lower bit error rate).

The memory control circuit 115 and memory array 120 can be configured to include one or more hybrid columns. For example, a breakout window 162 shows a cross-section of example memory cells from the memory array 120. The memory cells are indicated as boxes. In this example, columns of memory cells are in the direction indicated by the X-axis, rows of memory cells are in the direction indicated by the Y-axis, and pages of memory cells are in the direction indicated by the Z-axis. An example hybrid column 164 is shown. For a first portion of the pages indicated by 166, memory cells of the hybrid column 164 are used to store parity data, for example, for data stored at memory cells in other columns that are part of the same page (e.g., columns and rows of the same page). For a second portion of the pages indicated by 168, memory cells of the hybrid column 164 are used for another purpose such as, for example, for column redundancy as described herein.

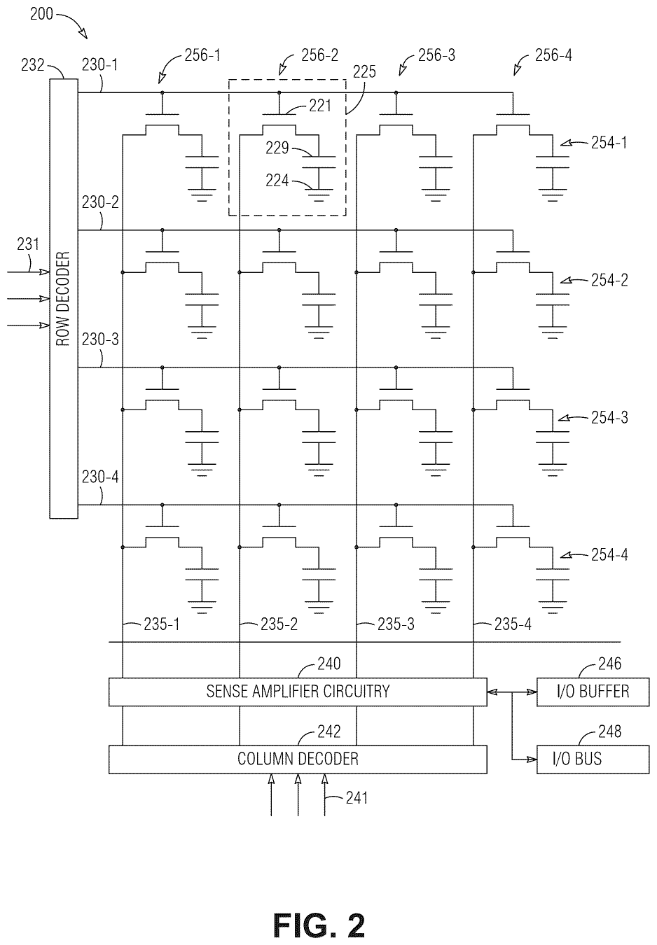

FIG. 2 is a schematic of an electrical arrangement of components of an embodiment of an example DRAM device 200, according to an embodiment. In an example, each of the memory cells 225 includes a GAA transistor 221 coupled to a capacitor 229. In some examples, the arrangement of FIG. 2 illustrates a page of memory cells 225. The memory cells 225 can be coupled to bit lines (BLs) 235, where each of the BLs 235 may be wrapped on a sidewall of an active area of the GAA transistor 221 of each memory cell 225 to which the BL 235 is coupled. Each word line (WL) 230 can be structured contacting gates of GAA transistors 221 of memory cells 225 to which the given WL 230 is coupled. The DRAM device 200 can include an array of memory cells 225 (only one being labeled in FIG. 2 for ease of presentation) arranged in rows 254-1, 254-2, 254-3, and 254-4 and columns 256-1, 256-2, 256-3, and 256-4. The physical orientation of the rows and columns is not shown. Further, while only four rows 254-1, 254-2, 254-3, and 254-4 and four columns 256-1, 256-2, 256-3, and 256-4 of memory cells are illustrated, DRAM devices, like DRAM device 200, can have significantly more memory cells 225 (for example, tens, hundreds, or thousands of memory cells) per row or per column.

In this example, each memory cell 225 can include a single transistor 221 and a single capacitor 229, which is commonly referred to as a 1T1C (one-transistor—one capacitor cell). One plate of capacitor 229, which can be termed the “node plate,” is connected to the drain terminal of transistor 221, whereas the other plate of the capacitor 229 is connected to ground 224 or other reference node. Each capacitor 229 within the array of 1T1C memory cells 225 typically serves to store one bit of data, and the respective transistor 221 serves as an access device to write to or read from storage capacitor 229.

The transistor gate terminals within each row of rows 254-1, 254-2, 254-3, and 254-4 are portions of respective WLs 230-1, 230-2, 230-3, and 230-4, and the transistor source terminals within each of columns 256-1, 256-2, 256-3, and 256-4 are electrically connected to respective BLs 235-1, 235-2, 235-3, and 235-4. A row decoder 232 can selectively drive the individual WLs 230-1, 230-2, 230-3, and 230-4, responsive to row address signals 231 input to row decoder 232. Driving a given WL 230 at a high voltage causes the access transistors within the respective row to conduct, thereby connecting the storage capacitors 229 within the row to the respective BLs 235, such that charge can be transferred between the BLs 235 and the storage capacitors 229 for read or write operations. Both read and write operations can be performed via SA circuitry 240, which can transfer bit values between memory cells 225 of the selected row of the rows 254-1, 254-2, 254-3, and 254-4 and input/output buffers 246 (for write/read operations) or external input/output data buses 248.

A column decoder 242 responsive to column address signals 241 can select which of the memory cells 225 within the selected row is read out or written to. Alternatively, for read operations, the storage capacitors 229 within the selected row can be read out simultaneously and latched, and the column decoder 242 can then select which latch bits to connect to the output data bus 248. Since read-out of the storage capacitors destroys the stored information, the read operation is accompanied by a rewrite of the capacitor charge. Further, in between read/write operations, the capacitor charge is repeatedly refreshed to prevent data loss.

DRAM device 200 can be implemented as an IC within a package that includes pins for receiving supply voltages (for example, to provide the source and gate voltages for the transistors 221) and signals (including data, address, and control signals). FIG. 2 depicts DRAM device 200 in simplified form to illustrate basic structural components, omitting many details of the memory cells 225 and associated WLs 230-1, 230-2, 230-3, and 230-4 and BLs 235-1, 235-2, 235-3, and 235-4 as well as the peripheral circuitry. For example, in addition to the row decoder 232, column decoder 242, Sense Amplifier (SA) circuitry 240, and buffers 246, DRAM device 200 can include further peripheral circuitry, such as a memory control circuit (e.g., the memory control circuit 115). The memory control circuit may control the memory operations based on control signals (provided, for example, by a host device, an external processor, etc.), additional input/output circuitry, or other features associated with a memory device. The peripheral circuitry can be located above the array of memory cells 225 in a CMOS over array (CoA) architecture using a wafer-on-wafer interconnect architecture. Alternatively, the peripheral circuitry can be located under the array of memory cells 225 in a CMOS under array (CuA) architecture. Alternatively, the peripheral circuitry can be located in a region of the IC of the memory device adjacent to an array region having the array of memory cells 225.

In two-dimensional (2D) DRAM arrays, the rows 254-1, 254-2, 254-3, and 254-4 and columns 256-1, 256-2, 256-3, and 256-4 of memory cells 225 can be arranged along a single horizontal plane (i.e., a plane parallel to the layers) of the semiconductor substrate, for example, in a rectangular lattice with WLs 230-1, 230-2, 230-3, and 230-4 and BLs 235-1, 235-2, 235-3, and 235-4. In 3D DRAM arrays, the memory cells 225 can be arranged in a 3D lattice with a page of memory cells and associated WLs and BLs at a level above another page of memory cells and their associated WLs and BLs.

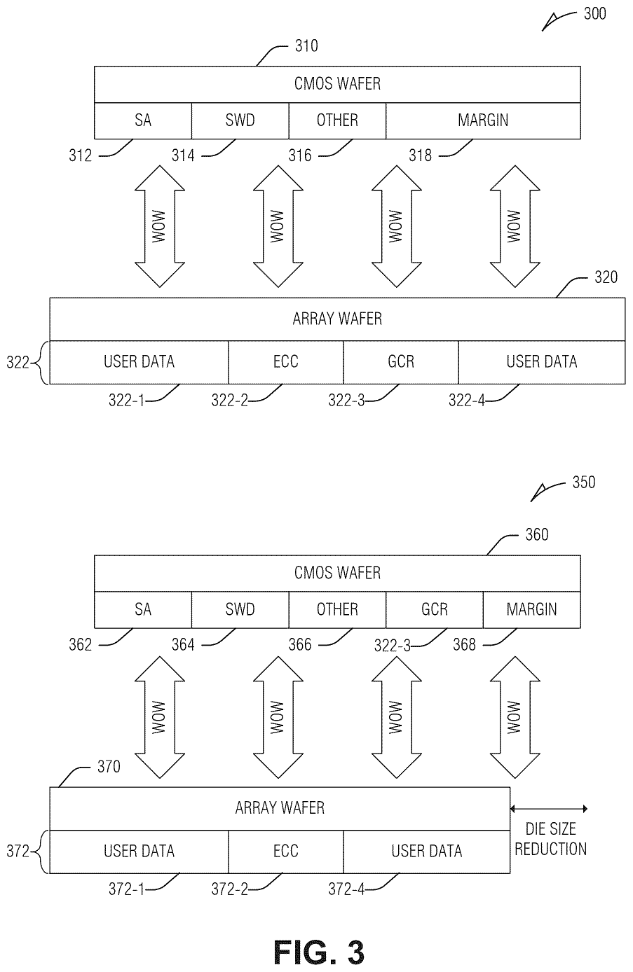

FIG. 3 is a diagram illustrating memory architectures, according to an embodiment. In a first architecture 300, a CMOS wafer 310 is stacked on an array wafer 320 using a wafer-on-wafer (WoW) interconnect architecture. The CMOS wafer 310 includes a sense amplifier (SA) 312, a sub-word line driver (SWD) 314, other circuitry 316, and a margin 318. The margin 318 is unused space on the CMOS wafer 310. The array wafer 320 includes DRAM array 322, which may be used to store user data 322-1, ECC data 322-2, GCR data 322-3, and user data 322-4. Although the CMOS wafer 310 is illustrated as a CoA arrangement over the array wafer 320, it is understood that the CMOS wafer 310 and array wafer 320 may be stacked in a CuA arrangement.

A second architecture 350 includes a CMOS wafer 360 stacked on an array wafer 370. Similar to the first architecture 300, the second architecture 350 includes an SA 362, SWD 364, other circuitry 366, and margin 368 in the CMOS wafer 360 and DRAM array 372 in the array wafer 370. The user data 372-1, ECC data 372-2, and user data 372-4 are stored in the DRAM array 372. However, some data that was stored in the DRAM array 352 of the first architecture 300 is disposed in the CMOS wafer 360, and the array wafer 370 benefits by a reduction in die size.

In the embodiment illustrated in FIG. 3, the GCR data 372-3 is stored in a memory device in the CMOS wafer 360. It is understood that some or all of the GCR data 372-3 may be stored in the memory device. Further, in other embodiments, ECC data 372-2, PRAC data (not shown), or other data, in full or in part (e.g., for some pages), may be stored in the memory device, depending on design. Although the CMOS wafer 360 is illustrated as a CoA arrangement over the array wafer 370, it is understood that the CMOS wafer 360 and array wafer 370 may be stacked in a CuA arrangement.

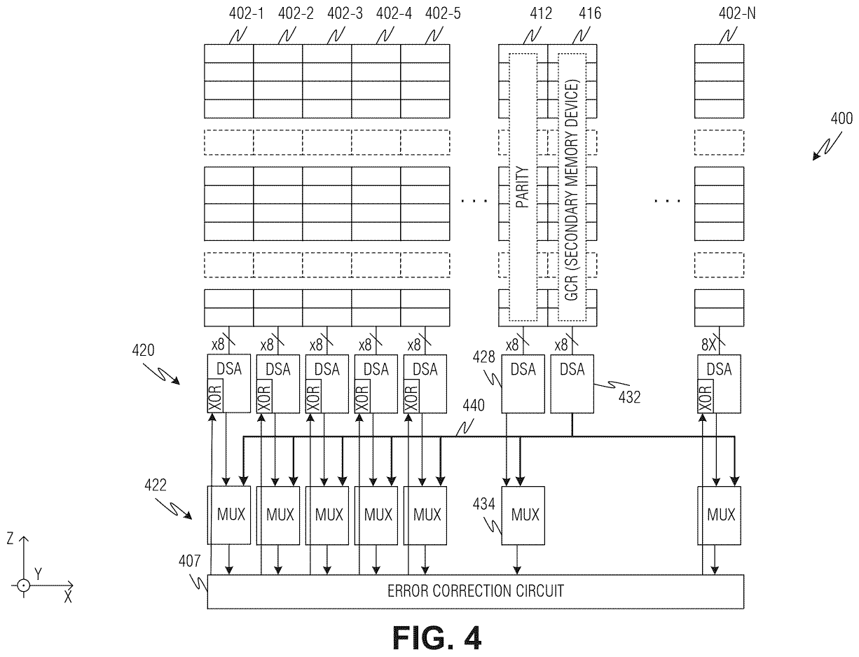

FIG. 4 is a diagram illustrating a memory device 400, according to an embodiment. In the example of FIG. 4, memory cells are arranged in three dimensions according to columns and rows positioned parallel to the X-Y plane and pages extending in the direction of the Z-axis. In the example illustrated in FIG. 4, rows of memory cells may extend into and/or out of the page in the direction of the Y-axis. Also, in the example of FIG. 4, columns 402-1, 402-2, 402-3, 402-4, . . . , 402-N, 412, and 416 are shown. It will be appreciated, however, that memory arrays as described herein may include more or fewer columns than are shown. Also, in this example, twelve pages are shown. It will be appreciated that memory arrays as described herein may include more or fewer than twelve pages. In the example of FIG. 4, each row includes eight memory cells, so a column of memory cells in a particular page includes eight bits. It will be appreciated, however, that memory arrays as described herein may include more or fewer than eight rows.

FIG. 4 shows an example of sensing circuitry for the respective columns including differential sense amplifiers (DSA) 420 and multiplexers (MUXs) 422. An error correction circuit 407 is also provided. In the example of FIG. 4, columns 402-1, 402-2, 402-3, 402-4, 402-5, 402-6 are data columns including memory cells that store payload data. For each data column 402, a respective differential sense amplifier (DSA) 420 may receive a column output sensed from the memory cells of the column and provide the column output to respective MUX 422. The MUXs 422 associated with data columns 402 may receive, in this example, two inputs. A first input may be received from the DSA 420 associated with the data column 402. A second input may be received from a column redundancy bus 440. The MUXs 422 may be configured, for example, by a control circuit 115, to provide a selected one of the inputs to the error correction circuit 407.

In the example of FIG. 4, the memory device 400 includes a logical column redundancy column 416 (e.g., GCR data). Sensing circuitry for the column redundancy column 416 may include a differential sense amplifier (DSA) 432. The DSA 432 may be configured to provide a column output read from the logical column redundancy column 416 to the column redundancy bus 440. In this way, if one of the data columns 402 is found to be defective, for example, during or after fabrication, then the particular MUX 422 associated with the defective data column 402 may be configured to pass the content of the column redundancy bus 440 to the data input of the error correction circuit 407. In this way, the column redundancy column 416 may act as a substitute for the defective data column 402.

The logical column redundancy column 416 is stored in a memory device of a CMOS wafer. Thus, although the column redundancy column 416 is illustrated as being a physical part of the memory array in FIG. 4, it corresponds to a different memory device. Circuitry connects the memory device to the DSA 432. Further, page, column, and row selection lines are sensed and used to control which data is sent from the memory device on the CMOS wafer to the DSA 432. For instance, outputs of row decoder 232 and column decoder 242 are sent to other circuitry 366 on CMOS wafer 360, array controller 135, memory device 145, or a controller of memory device 145 (e.g., control circuit 115), in order to determine the corresponding value to send to the DSA 432.

The memory device 400 includes a parity column 412 that stores parity data. For example, the parity column 412 may store eight bits of parity data for each page. In examples in which there are eight data columns, this may come to a single parity bit for each data column. Sensing circuitry for the parity column 412 may comprise a differential sense amplifier (DSA) 428 and a MUX 434.

The MUX 434 may have two inputs. A first input may receive the column output of the parity column 412 provided by the differential sense amplifier (DSA) 428. A second input may receive the column redundancy bus 440. The MUX 434 may be configured to direct either the column output of the parity column 412 (from the DSA 428), or the column redundancy bus 440 to the error correction circuit 407. In this way, if the parity column 412 is determined to be defective, then a column redundancy column, such as column 416, may be used to store parity data.

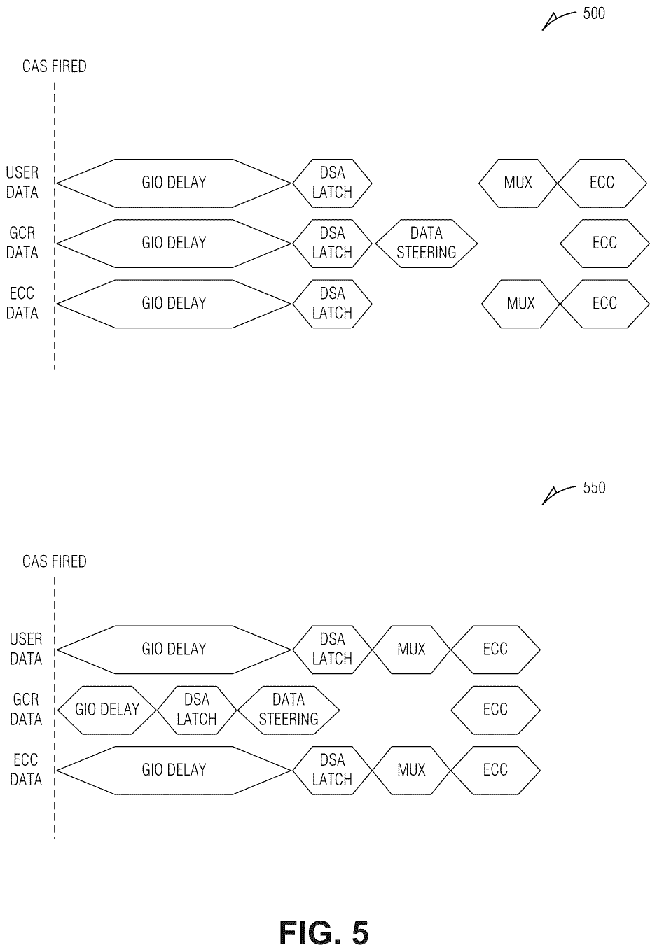

FIG. 5 illustrates timing diagrams of a “read command to first data” measurement, according to an embodiment. In a first timing diagram 500, which corresponds to a first architecture 300, after a column address strobe (CAS) is fired, user data, GCR data, and ECC data is read from a memory array. Each read experiences a general-purpose input/output (GIO) delay (e.g., time to signal data from a sense amplifier to a differential sense amplifier), a time for DSA latch, and then the GCR data experiences a delay for data steering. The data steering delay has to be completed before the MUX can operate on the signals to determine which output signal to send to the error correction circuit.

In contrast, in a second timing diagram 550, which corresponds to a second architecture 350, after a column address strobe (CAS) is fired, user data, and ECC data is read from a memory array, but the GCR data is read from the memory device on the CMOS wafer. Each of the user data and ECC data experience a general-purpose input/output delay (e.g., time to signal data from a sense amplifier to a differential sense amplifier). However, the GCR data, which is read from a faster memory device (e.g., SRAM) has a reduced GIO delay. This allows the GCR data to complete the DSA latch and any data steering delay earlier than in the previous arrangement, and in some instances, before the MUX operation is ready to be performed. The MUX can operate on the signals sooner (without the data steering delay) to determine which output signal to send to the error correction circuit (e.g., error correction circuit 407) for error correction processing.

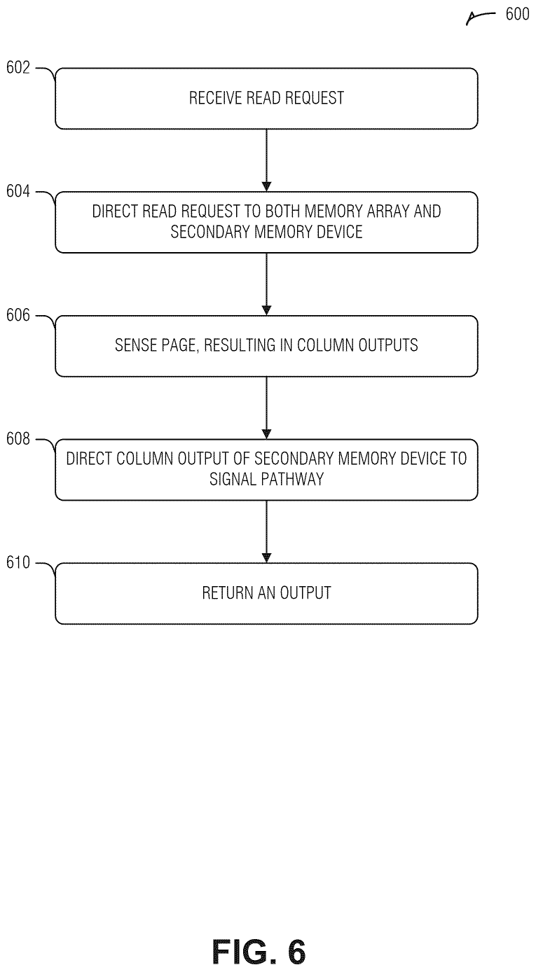

FIG. 6 is a flowchart illustrating an example method 600 that may be implemented in a memory device to respond to a read request, according to an embodiment. The method 600 can be performed by processing logic that can include hardware (e.g., processing device, circuitry, dedicated logic, programmable logic, microcode, hardware of a device, integrated circuit, etc.). The method 600 may be executed using any suitable memory device, such as those described herein in FIGS. 1-5.

At operation 602, a memory device may receive a read request. The read request may specify an address at a memory array of the memory device (e.g., a logical address or a physical address). The address may correlate to a page or portion of a page that is to be read.

At operation 604, the memory device may direct the read request to both the memory array and a secondary memory device, the secondary memory device being on a different wafer than the memory array. The secondary memory device may be an SRAM module. The different wafer may be a CMOS wafer, where the memory array is on a DRAM wafer.

At operation 606, the memory device may sense the page, resulting in a set of column outputs. The column outputs from both the memory array and the secondary memory device.

At operation 608, the memory device may direct the column output of the secondary memory device to a corresponding signal pathway. The signal pathway may be a bus, such as a column redundancy bus when the secondary memory device is configured to store GCR data. Alternatively, the secondary pathway may be a line to a MUX for parity data when the secondary memory device is configured to store ECC data. Other configurations are also used based on the type of data the secondary device is configured to store.

As described herein, the memory device may comprise MUXs respectively associated with columns that are not column redundancy columns. The MUXs may be selectively configured to provide the output at the column redundancy bus to the error correction circuit in place of a column output of one of the other columns.

At operation 610, the memory device may return an output. The output may be, for example, a verified or corrected data output from an error correction circuit.

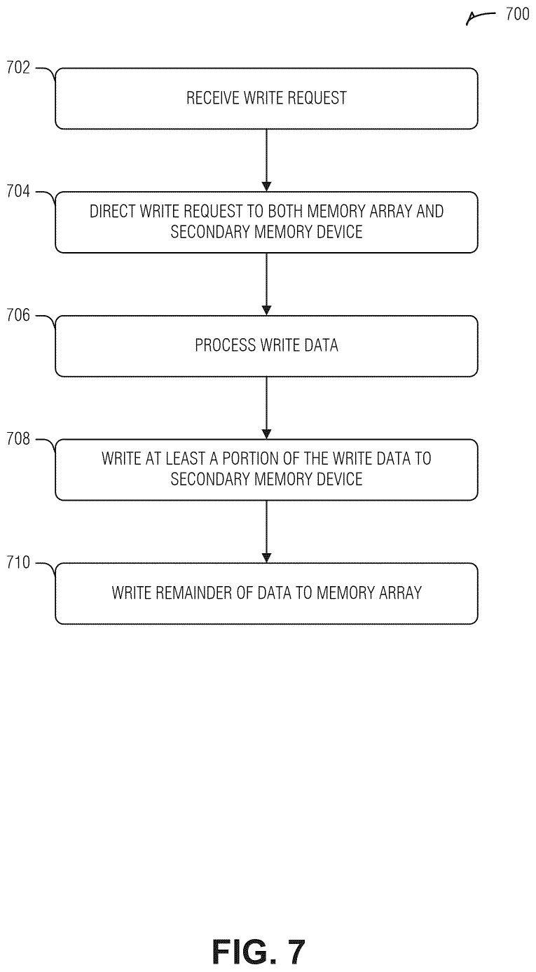

FIG. 7 is a flowchart illustrating an example method 700 that may be implemented in a memory device to respond to a write request, according to an embodiment. The method 700 can be performed by processing logic that can include hardware (e.g., processing device, circuitry, dedicated logic, programmable logic, microcode, hardware of a device, integrated circuit, etc.). The method 700 may be executed using any suitable memory device, such as those described herein in FIGS. 1-5.

At operation 702, the memory device may receive a write request. The write request may include, for example, data to be written to a memory array of the memory device. In some examples, the write request includes an address indicating where the data should be written to in the memory array. In some examples, the memory device determines where the data should be written to in the memory array, for instance, based on the available allocated range of memory assigned to operations associated with the write request.

At operation 704, the memory device may direct the write request to both the memory array and a secondary memory device, the secondary memory device being on a different wafer than the memory array. The secondary memory device may be an SRAM module. The different wafer may be a CMOS wafer, where the memory array is on a DRAM wafer.

At operation 706, the data to be written may be processed, at least partially, before data is sent to the secondary memory device for storage. Depending on the type of data the secondary memory device is configured to store (e.g., GCR data, ECC data, PRAC data, etc.), the data to be written to the secondary memory device may be calculated or processed based on other data to be written to the memory array. For instance, if the secondary memory device is configured to store parity data, then at operation 706, parity data is determined for the data to be written. In the case where the secondary memory device is configured to store GCR data, the memory device may be configured to transmit a bit to the secondary memory device for a cell that has failed in the corresponding memory array row.

At operation 708, the memory device may write at least a portion of the data to the secondary memory device. At operation 710, the memory device may write the remainder of the data to a portion of the memory array. In some examples, the operations 708 and 710 may be performed simultaneously.

Although shown in a particular sequence or order, unless otherwise specified, the order of the methods or processes described herein can be modified. Thus, the illustrated embodiments should be understood only as examples, and the illustrated processes can be performed in a different order, and some processes can be performed in parallel. Additionally, one or more processes can be omitted in various embodiments. Thus, not all processes are used in every embodiment. Other process flows are possible.

FIG. 8 illustrates a block diagram of an example machine 800 with which, in which, or by which any one or more of the techniques (e.g., methodologies) discussed herein can be implemented. Examples, as described herein, can include, or can operate by, logic or a number of components, or mechanisms in the machine 800. Circuitry (e.g., processing circuitry) is a collection of circuits implemented in tangible entities of the machine 800 that include hardware (e.g., simple circuits, gates, logic, etc.). Circuitry membership can be flexible over time. Circuitries include members that can, alone or in combination, perform specified operations when operating. In an example, hardware of the circuitry can be immutably designed to carry out a specific operation (e.g., hardwired). In an example, the hardware of the circuitry can include variably connected physical components (e.g., execution units, transistors, simple circuits, etc.) including a machine readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, in an example, the machine-readable medium elements are part of the circuitry or are communicatively coupled to the other components of the circuitry when the device is operating. In an example, any of the physical components can be used in more than one member of more than one circuitry. For example, under operation, execution units can be used in a first circuit of a first circuitry at one point in time and reused by a second circuit in the first circuitry, or by a third circuit in a second circuitry at a different time. Additional examples of these components with respect to the machine 800.

In alternative embodiments, the machine 800 can operate as a standalone device or can be connected (e.g., networked) to other machines. In a networked deployment, the machine 800 can operate in the capacity of a server machine, a client machine, or both in server-client network environments. In an example, the machine 800 can act as a peer machine in peer-to-peer (P2P) (or other distributed) network environment. The machine 800 can be a personal computer (PC), a manufacturing control device, a web appliance, a network router, switch or bridge, embedded memory controller, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

The machine 800 (e.g., computer system) can include a hardware processor 802 (e.g., a central processing unit (CPU), a graphics processing unit (GPU), a hardware processor core, or any combination thereof), a main memory 804, a static memory 806 (e.g., memory or storage for firmware, microcode, a basic-input-output (BIOS), unified extensible firmware interface (UEFI), etc.), and mass storage device 808 (e.g., hard drives, tape drives, flash storage, or other block devices) some or all of which can communicate with each other via an interlink 830 (e.g., bus). The machine 800 can further include a display device 810, an alphanumeric input device 812 (e.g., a keyboard), and a user interface (UI) Navigation device 814 (e.g., a mouse). In an example, the display device 810, the input device 812, and the UI navigation device 814 can be a touch screen display. The machine 800 can additionally include a mass storage device 808 (e.g., a drive unit), a signal generation device 818 (e.g., a speaker), a network interface device 820, and one or more sensor(s) 816, such as a global positioning system (GPS) sensor, compass, accelerometer, or other sensor. The machine 800 can include an output controller 828, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

Registers of the hardware processor 802, the main memory 804, the static memory 806, or the mass storage device 808 can be, or include, a machine-readable media 822 on which is stored one or more sets of data structures or instructions 824 (e.g., software) embodying or used by any one or more of the techniques or functions described herein. The instructions 824 can also reside, completely or at least partially, within any of registers of the hardware processor 802, the main memory 804, the static memory 806, or the mass storage device 808 during execution thereof by the machine 800. In an example, one or any combination of the hardware processor 802, the main memory 804, the static memory 806, or the mass storage device 808 can constitute the machine-readable media 822. While the machine-readable media 822 is illustrated as a single medium, the term “machine-readable medium” can include a single medium or multiple media (e.g., a centralized or distributed database, or associated caches and servers) configured to store the one or more instructions 824.

The term “machine readable medium” can include any medium that is capable of storing, encoding, or carrying instructions for execution by the machine 800 and that cause the machine 800 to perform any one or more of the techniques of the present disclosure, or that is capable of storing, encoding, or carrying data structures used by or associated with such instructions. Non-limiting machine-readable medium examples can include solid-state memories, optical media, magnetic media, and signals (e.g., radio frequency signals, other photon-based signals, sound signals, etc.). In an example, a non-transitory machine-readable medium comprises a machine-readable medium with a plurality of particles having invariant (e.g., rest) mass, and thus are compositions of matter. Accordingly, non-transitory machine-readable media are machine readable media that do not include transitory propagating signals. Specific examples of non-transitory machine readable media can include: non-volatile memory, such as semiconductor memory devices (e.g., electrically programmable read-only memory (EPROM), electrically erasable programmable read-only memory (EEPROM)) and flash memory devices; magnetic disks, such as internal hard disks and removable disks; magneto-optical disks; and CD-ROM and DVD-ROM disks.

In an example, information stored or otherwise provided on the machine-readable media 822 can be representative of the instructions 824, such as instructions 824 themselves or a format from which the instructions 824 can be derived. This format from which the instructions 824 can be derived can include source code, encoded instructions (e.g., in compressed or encrypted form), packaged instructions (e.g., split into multiple packages), or the like. The information representative of the instructions 824 in the machine-readable media 822 can be processed by processing circuitry into the instructions to implement any of the operations discussed herein. For example, deriving the instructions 824 from the information (e.g., processing by the processing circuitry) can include: compiling (e.g., from source code, object code, etc.), interpreting, loading, organizing (e.g., dynamically or statically linking), encoding, decoding, encrypting, unencrypting, packaging, unpackaging, or otherwise manipulating the information into the instructions 824.

In an example, the derivation of the instructions 824 can include assembly, compilation, or interpretation of the information (e.g., by the processing circuitry) to create the instructions 824 from some intermediate or preprocessed format provided by the machine-readable media 822. The information, when provided in multiple parts, can be combined, unpacked, and modified to create the instructions 824. For example, the information can be in multiple compressed source code packages (or object code, or binary executable code, etc.) on one or several remote servers. The source code packages can be encrypted when in transit over a network and decrypted, uncompressed, assembled (e.g., linked) if necessary, and compiled or interpreted (e.g., into a library, stand-alone executable etc.) at a local machine, and executed by the local machine.

The instructions 824 can be further transmitted or received over a communications network 826 using a transmission medium via the network interface device 820 utilizing any one of a number of transfer protocols (e.g., frame relay, internet protocol (IP), transmission control protocol (TCP), user datagram protocol (UDP), hypertext transfer protocol (HTTP), etc.). Example communication networks can include a local area network (LAN), a wide area network (WAN), a packet data network (e.g., the Internet), mobile telephone networks (e.g., cellular networks), plain old telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 820 can include one or more physical jacks (e.g., Ethernet, coaxial, or phone jacks) or one or more antennas to connect to the network 826. In an example, the network interface device 820 can include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 800, and includes digital or analog communications signals or other intangible medium to facilitate communication of such software. A transmission medium is a machine readable medium.

To better illustrate the methods and apparatuses described herein, a non-limiting set of Example embodiments are set forth below as numerically identified Examples.

Example 1 is a memory device comprising: a complementary metal-oxide-semiconductor (CMOS) wafer, the CMOS wafer including controller circuitry and a secondary memory device; and a memory array wafer comprising a memory array of a plurality of memory cells, the memory array wafer stacked on the CMOS wafer using wafer-on-wafer interconnect architecture, the plurality of memory cells arranged in pages, rows, and columns, wherein the secondary memory device is configured to store metadata for at least a portion of the pages.

In Example 2, the subject matter of Example 1 includes, wherein the metadata comprises global column redundancy (GCR) data, and wherein the memory device comprises: a column redundancy bus; sensing circuitry electrically coupled to sense signals from the secondary memory device, and the sensing circuitry being electrically coupled to provide a column output to the column redundancy bus when the memory array is configured for reading a page.

In Example 3, the subject matter of Example 2 includes, a second sensing circuitry electrically coupled to sense memory cells of a second column of the memory array, the second sensing circuitry being electrically coupled to provide a second column output to a data input of error correction circuitry.

In Example 4, the subject matter of Examples 1-3 includes, wherein the metadata comprises global column redundancy (GCR) data, and wherein the controller circuitry is configured to: receive write data for writing to a page in the memory array; determine GCR data for the write data; write the GCR data to the secondary memory device; and write the write data to the memory array.

In Example 5, the subject matter of Examples 1-4 includes, wherein the metadata comprises parity data, and wherein the memory device comprises: error correction circuity including a parity bit input; and a sensing circuitry electrically coupled to sense signals from the secondary memory device, and the sensing circuitry being electrically coupled to provide a parity output to a parity multiplexer (MUX) when the memory array is configured for reading a page.

In Example 6, the subject matter of Example 5 includes, a second sensing circuitry electrically coupled to sense memory cells of a second column of the memory array, the second sensing circuitry being electrically coupled to provide a second column output to a data input of the error correction circuitry.

In Example 7, the subject matter of Examples 1-6 includes, wherein the metadata comprises parity data, and wherein the controller circuitry is configured to: receive write data for writing to a page in the memory array; determine parity data for the write data; write the parity data to the secondary memory device; and write the write data to the memory array.

In Example 8, the subject matter of Examples 1-7 includes, wherein the memory device is a Dynamic Random-Access Memory (DRAM) module.

In Example 9, the subject matter of Examples 1-8 includes, wherein the secondary memory device is based on CMOS technology.

In Example 10, the subject matter of Example 9 includes, wherein the secondary memory device is a static random-access memory (SRAM) module.

Example 11 is a method of operating a memory device, the method comprising: configuring a memory array of the memory device for reading a page of a number of pages; while the memory array is configured for reading the page: sensing column outputs from a plurality of data columns in the memory array; and sensing the column output from a secondary memory device on a CMOS wafer of the memory device; and providing the column outputs from the plurality of data columns and the column output from the secondary memory device to an input of error correction circuitry of the memory device.

In Example 12, the subject matter of Example 11 includes, wherein the column output from the secondary memory device comprises global column redundancy data associated with the column outputs from the plurality of data columns.

In Example 13, the subject matter of Examples 11-12 includes, wherein the column output from the secondary memory device comprises parity data associated with the column outputs from the plurality of data columns.

In Example 14, the subject matter of Examples 11-13 includes, wherein the column output from the secondary memory device comprises per row activation counting (PRAC) data associated with the column outputs from the plurality of data columns.

In Example 15, the subject matter of Examples 11-14 includes, wherein the memory device comprises a complementary metal-oxide-semiconductor (CMOS) wafer and a memory array wafer, the memory array wafer stacked on the CMOS wafer using wafer-on-wafer interconnect architecture.

In Example 16, the subject matter of Example 15 includes, wherein the CMOS wafer comprises the secondary memory device.

In Example 17, the subject matter of Example 16 includes, wherein the memory array wafer comprises the memory array, the memory array comprising a number of memory cells arranged into a number of pages, a number of rows, and a number of columns, with each respective memory cell of the number of memory cells being part of a particular column of the number of columns, a particular row of the number of rows, and a particular page of the number of pages.

In Example 18, the subject matter of Examples 11-17 includes, wherein the column output from the secondary memory device comprises global column redundancy (GCR) data, and wherein the method comprises: providing the column output to a column redundancy bus when the memory array is configured for reading a page.

In Example 19, the subject matter of Examples 11-18 includes, sensing a parity output of the error correction circuitry of the memory device.

Example 20 is a memory device comprising: a complementary metal-oxide-semiconductor (CMOS) wafer, the CMOS wafer including controller circuitry and a secondary memory device; and a memory array wafer comprising a memory array of a plurality of memory cells, the memory array wafer stacked on the CMOS wafer, the plurality of memory cells arranged in pages, rows, and columns, wherein the secondary memory device is configured to store metadata for at least a portion of the pages; means for configuring the memory array for reading a page of the pages; means for sensing column outputs from a plurality of data columns in the memory array; means for sensing the column output from the secondary memory device on the CMOS wafer; and means for providing the column outputs from the plurality of data columns and the column output from the secondary memory device to an input of error correction circuitry of the memory device.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” can include “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) can be used in combination with each other. Other embodiments can be used, such as by one of ordinary skill in the art upon reviewing the above description. It is submitted with the understanding that it will not be used to interpret or limit the scope or meaning of the claims. Also, in the above Detailed Description, various features can be grouped together to streamline the disclosure. This should not be interpreted as intending that an unclaimed disclosed feature is essential to any claim. Rather, inventive subject matter can lie in less than all features of a particular disclosed embodiment. Thus, the following claims are hereby incorporated into the Detailed Description, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed is:

1. A memory device comprising:
a complementary metal-oxide-semiconductor (CMOS) wafer, the CMOS wafer including controller circuitry and a secondary memory device; and
a memory array wafer comprising a memory array of a plurality of memory cells, the memory array wafer stacked on the CMOS wafer using wafer-on-wafer interconnect architecture, the plurality of memory cells arranged in pages, rows, and columns,
wherein the secondary memory device is configured to store metadata for at least a portion of the pages.

2. The memory device of claim 1, wherein the metadata comprises global column redundancy (GCR) data, and wherein the memory device comprises:
a column redundancy bus;
sensing circuitry electrically coupled to sense signals from the secondary memory device, and the sensing circuitry being electrically coupled to provide a column output to the column redundancy bus when the memory array is configured for reading a page.

3. The memory device of claim 2, further comprising a second sensing circuitry electrically coupled to sense memory cells of a second column of the memory array, the second sensing circuitry being electrically coupled to provide a second column output to a data input of error correction circuitry.

4. The memory device of claim 1, wherein the metadata comprises global column redundancy (GCR) data, and wherein the controller circuitry is configured to:
receive write data for writing to a page in the memory array;
determine GCR data for the write data;
write the GCR data to the secondary memory device; and
write the write data to the memory array.

5. The memory device of claim 1, wherein the metadata comprises parity data, and wherein the memory device comprises:
error correction circuity including a parity bit input; and
a sensing circuitry electrically coupled to sense signals from the secondary memory device, and the sensing circuitry being electrically coupled to provide a parity output to a parity multiplexer (MUX) when the memory array is configured for reading a page.

6. The memory device of claim 5, further comprising a second sensing circuitry electrically coupled to sense memory cells of a second column of the memory array, the second sensing circuitry being electrically coupled to provide a second column output to a data input of the error correction circuitry.

7. The memory device of claim 1, wherein the metadata comprises parity data, and wherein the controller circuitry is configured to:
receive write data for writing to a page in the memory array;
determine parity data for the write data;
write the parity data to the secondary memory device; and
write the write data to the memory array.

8. The memory device of claim 1, wherein the memory device is a Dynamic Random-Access Memory (DRAM) module.

9. The memory device of claim 1, wherein the secondary memory device is based on CMOS technology.

10. The memory device of claim 9, wherein the secondary memory device is a static random-access memory (SRAM) module.

11. A method of operating a memory device, the method comprising:
configuring a memory array of the memory device for reading a page of a number of pages;
while the memory array is configured for reading the page:
sensing column outputs from a plurality of data columns in the memory array; and
sensing the column output from a secondary memory device on a CMOS wafer of the memory device; and
providing the column outputs from the plurality of data columns and the column output from the secondary memory device to an input of error correction circuitry of the memory device.

12. The method of claim 11, wherein the column output from the secondary memory device comprises global column redundancy data associated with the column outputs from the plurality of data columns.

13. The method of claim 11, wherein the column output from the secondary memory device comprises parity data associated with the column outputs from the plurality of data columns.

14. The method of claim 11, wherein the column output from the secondary memory device comprises per row activation counting (PRAC) data associated with the column outputs from the plurality of data columns.

15. The method of claim 11, wherein the memory device comprises a complementary metal-oxide-semiconductor (CMOS) wafer and a memory array wafer, the memory array wafer stacked on the CMOS wafer using wafer-on-wafer interconnect architecture.

16. The method of claim 15, wherein the CMOS wafer comprises the secondary memory device.

17. The method of claim 16, wherein the memory array wafer comprises the memory array, the memory array comprising a number of memory cells arranged into a number of pages, a number of rows, and a number of columns, with each respective memory cell of the number of memory cells being part of a particular column of the number of columns, a particular row of the number of rows, and a particular page of the number of pages.

18. The method of claim 11, wherein the column output from the secondary memory device comprises global column redundancy (GCR) data, and wherein the method comprises:
providing the column output to a column redundancy bus when the memory array is configured for reading a page.

19. The method of claim 11, comprising sensing a parity output of the error correction circuitry of the memory device.

20. A memory device comprising:
a complementary metal-oxide-semiconductor (CMOS) wafer, the CMOS wafer including controller circuitry and a secondary memory device; and
a memory array wafer comprising a memory array of a plurality of memory cells, the memory array wafer stacked on the CMOS wafer, the plurality of memory cells arranged in pages, rows, and columns, wherein the secondary memory device is configured to store metadata for at least a portion of the pages;
means for configuring the memory array for reading a page of the pages;
means for sensing column outputs from a plurality of data columns in the memory array;
means for sensing the column output from the secondary memory device on the CMOS wafer; and
means for providing the column outputs from the plurality of data columns and the column output from the secondary memory device to an input of error correction circuitry of the memory device.
